(19) United States
(12) Patent Application Publication
(10) Pub. No.: US 2007/0266434 A1
(43) Pub. Date: Nov. 15, 2007

(54) Protecting Applications Software Against Unauthorized Access, Reverse Engineering or Tampering

(75) Inventor: Donald J. Reifer, Torrance, CA (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Reifer Consultants, Inc., Torrance, CA (US)

(21) Appl. No.: 11/382,768

(22) Filed: May 11, 2006

(51) Int. Cl. G06F 12/14

(52) U.S. Cl. 726/22

(57) ABSTRACT

A system, method and program for protecting applications software from unauthorized access, reverse engineering or tampering, is disclosed. Protection of the application software may be accomplished by seeding the application software with sneak circuits based on performance indicators; running the application software in test mode to analyze performance indicators versus protection indicators of the application software; modifying seeding if the performance indicators and the protection indicators reach a predetermined tradeoff value; and inserting active protection code in the application software. Additional protection can be accomplished by executing a protected version of the application software in normal mode and collecting forensics data while executing the protected version.

### REFERENCE TO GOVERNMENT

The invention was made with Government support under contract DASG60-03-C-0067 awarded by the U.S. Army Space and Missile Defense Command. The Government has certain rights in the invention.

### BACKGROUND OF THE INVENTION

1. Field of the Invention

The present invention relates to a system, method and program for protecting applications software from unauthorized access, reverse engineering or tampering. More particularly, the present invention relates to a system, method and program for protecting application software executables from unauthorized access, reverse engineering or tampering.

2. Discussion of the Related Art

Software cracking is the unauthorized modification and subsequent misuse of software that typically requires disabling one or more software feature used to enforce protective technologies related to the software. Because of the proprietary value and sensitive nature of many software applications and data associated therewith, anti-tamper technologies have been developed to protect valuable software and hardware. Anti-tamper technologies share the same goals of making software more resistant against attacks, protecting critical source code elements and protecting data and hardware associated with executables. Unfortunately, the various types of known anti-tamper technology often achieve only one or two of these goals while having a negative impact on the performance of the software, hardware and/or operating system.

Anti-tamper technologies are provided on computers, over the Internet, and via intranets by a variety of methods. A popular form of anti-tamper technology for applications software is encryption, the process of encoding information in such a way that only a person or computer with a key can decode it. While providing security, encrypted files stored on a computer suffer severe performance penalties when accessed repeatedly as data must be decrypted before it is executed and encrypted again before it is stored back in its original vault. In response, often files are operated on in the clear when performance is an issue. This makes the files vulnerable to crackers who run the software as they reverse engineer it to access critical data and algorithms.

Other anti-tamper technologies are also available for preventing unauthorized access and subsequent misuse of software, e.g., software cracking. One such variety inserts software guards into the program to protect it against software cracking. Another form of protection obfuscates the program by putting false logic within it to prevent humans from understanding it. Software may also be protected using counters, encoding schemes, hidden data, watermarks, and/or checksums to protect it against unauthorized access. However, as noted above in the referenced literature, off-the-shelf reverse engineering tools and technology can easily be used to counter most of these forms of protection. In addition, some of these types of protection can have a negative impact on the performance of the software and/or operating systems resulting in increased run-times, increased cache and memory utilization, decreased transmission speeds, and the like. Still other anti-tamper technologies only provide software protection at certain times while leaving it exposed at other times. For example, some encryption-protection software must be decrypted in order to run, leaving it exposed to potential software cracking while running.

Based on the foregoing, there exists a need for in depth software protection to ensure that critical software information (proprietary or classified data, critical algorithms, etc.) does not fall into the hands of those who may use it for criminal or other purposes. There also exists a need for active and passive software protection. There exists yet another need for performance-sensitive software and hardware protection from unauthorized access, reverse engineering or tampering.

### SUMMARY OF THE INVENTION

It is an object of the present invention to provide active and passive protection for application software and hardware. It is a further object of the present invention to provide performance-sensitive protection for application software and hardware. It is still a further object of the present invention to provide in depth protection for application software and hardware.

These and other objects and advantages of the present invention are accomplished by a system, method and program for protecting application software from unauthorized access, reverse engineering or tampering in accordance with the present invention. In one embodiment, the method includes seeding the application software with sneak circuits based on performance indicators; running the application software in test mode after seeding; analyzing performance indicators and protection indicators of the application software while running the application software in test mode; modifying seeding if the performance indicators and the protection indicators reach a predetermined tradeoff value; and inserting active protection code in the application software.

In an alternate embodiment, there is a system for protecting application software from unauthorized access, reverse engineering or tampering in accordance with the present invention. The system includes a seeding module for augmenting the application software with sneak circuits based on performance indicators; a running module for analyzing the performance indicators and protection indicators of the application software in test mode after seeding; a modifying module for updating seeding if the performance indicators and the protection indicators reach a predetermined tradeoff value; and a protecting module for inserting active protection code in the application software.

In another alternate embodiment, there is a computer program for protecting application software from unauthorized access, reverse engineering or tampering in accordance with the present invention. The computer program includes a computer code segment for seeding the application software with sneak circuits based on performance indicators; a computer code segment for running the application software in test mode after seeding, the running for analyzing the performance indicators and protection indicators of the application software; a computer code segment for modifying seeding if the performance indicators and the protection indicators reach a predetermined tradeoff value; and a computer code segment for inserting active protection code in the application software.

The invention will be further described with reference to the following detailed description taken in conjunction with the drawings.

### DESCRIPTION OF DRAWINGS

FIG. 1 is a flowchart illustrating one embodiment of a software sneak circuit analysis protection methodology in accordance with the present invention;

FIG. 2 is a flowchart of one embodiment of a characterize application and threat procedure in accordance with FIG. 1;

FIG. 3 is a flowchart of one embodiment of a perform static metrics analysis procedure in accordance with FIG. 1;

FIG. 4 is a flowchart illustrating one embodiment of a perform dynamic metrics analysis procedure in accordance with FIG. 1;

FIG. 5 is a flowchart illustrating one embodiment of a seed target source code with software sneak circuits procedure in accordance with FIG. 1;

FIG. 6 is a flowchart of one embodiment for analyzing performance indicators and protection indicators in accordance with FIG. 1;

FIG. 7 is a flowchart illustrating one embodiment of a condition executable and release procedure in accordance with FIG. 1;

FIG. 8 is a flowchart illustrating on embodiment of an insert active protection code procedure in accordance with FIG. 1;

FIG. 9 is a flowchart of one embodiment of a procedure for actively responding to reverse engineering and tampering exploits in accordance with FIG. 1; and

FIG. 10 is a flowchart of one embodiment of a procedure that uses forensics data to improve the software sneak circuit analysis methodology in accordance with FIG. 1.

### DETAILED DESCRIPTION

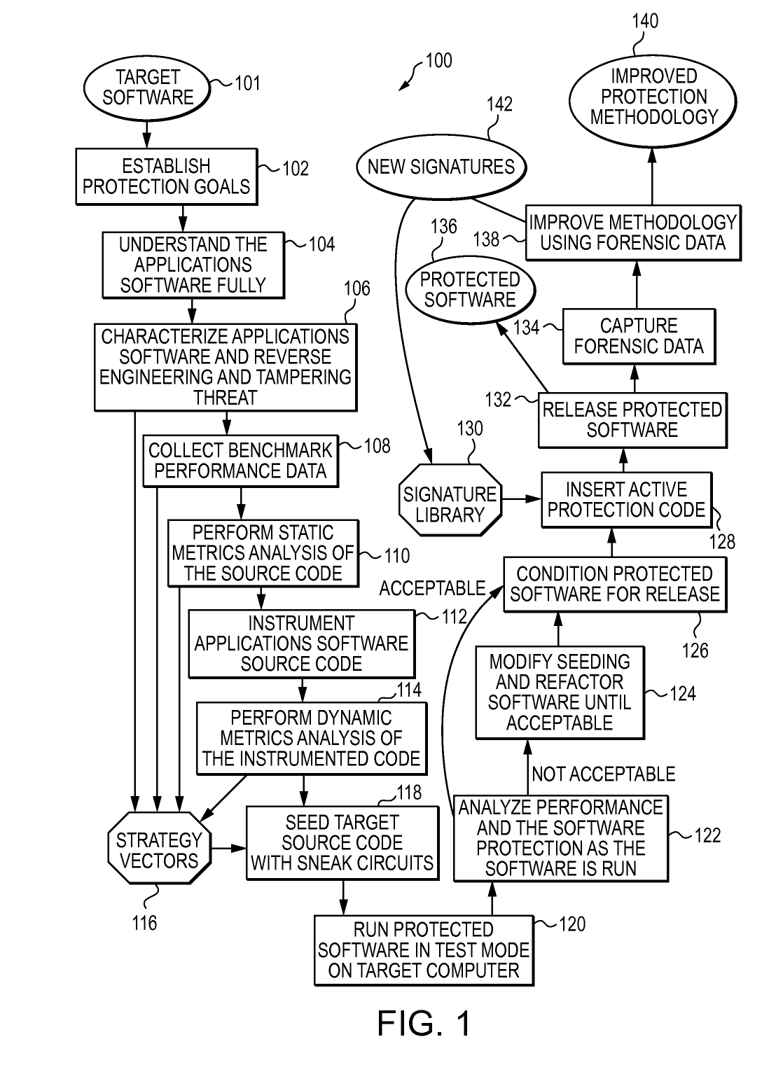

Referring to FIG. 1, one embodiment of a process for protecting application software from reverse engineering and tampering is generally indicated as 100 (hereinafter the “protection process”). Protection process 100 is applied to target application software 101 to create protected application software 136. Protection process 100 may begin by establishing protection goals 102 for particular target application software 101. One skilled in the art can appreciate that protection goals 102 vary depending on the type of target application software 101 being protected. One skilled in the art can also appreciate that protection goals 102 can be correlated with general categories of target application software 101 to provide easy and quick identification of protection goals 102. This can be accomplished via relational databases, knowledge oriented programming and other known techniques. One skilled in the art can further appreciate that target application software 101 can include software for weapons systems, automated teller machine (ATM) software, software used with gambling equipment and software for wireless devices.

Once protection goals 102 are identified for target application software 101, protection process 100 includes a step for fully analyzing and understanding target application software 104. Target application software 101 is analyzed by collecting performance indicator data and metrics information from the source code version of the target application software 101 using specialized tools. This step involves analyzing all aspects of the source code version of target application software 101, including physical appearance of the code, data structures, control flow, and the like.

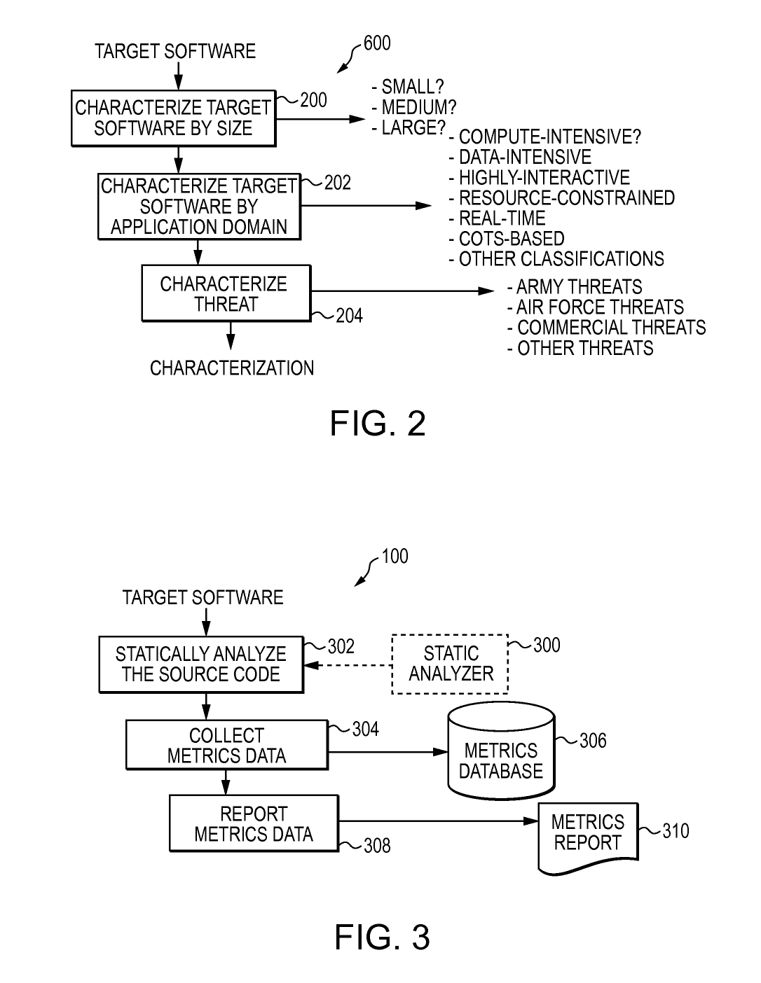

Protection process 100 characterizes applications software 101 and performs a threat procedure 106. FIG. 2 illustrates one embodiment for characterizing application software 101 and performing a threat procedure 106. Target application software 101 can be characterized as a function of size, i.e. small, medium or large, 200. Those skilled in the art can appreciate that size of target software 101 can be based on the number of code lines, memory required to store the code, or a combination thereof. Target application software 101 can be further characterized as a function of application domain 202. Those skilled in the art can appreciate that application domains include compute-intensive applications, data-intensive applications, highly-interactive applications, resource-constrained applications, real-time applications, commercial-off-the-shelf (COTS)-based applications, and the like. In one embodiment, target application software 101 is categorized as only one type of application domain. In an alternate embodiment, application domains are ranked in decreasing applicability for various target application software 101. Target application software 101 can be further characterized as a function of the type of threat possible if target application software 101 were reversed engineered or otherwise exploited. These different types of threats can include military threats, government threats, commercial threats, and the like. Those skilled in the art can appreciate that target application software 101 can be characterized as a function of size, application domain and threat, as well as other factors, in any order and according to varying weight being applied to these various factors. Threat procedure 106 results in defining a threat to target application software 101 using a unique representation called a threat vector, which is one of potentially many strategy vectors 116 used in protection process 100.

Protection process 100 includes a step for collecting benchmark performance indicator data 108. Another strategy vector 116 can be generated based on performance indicator data.

In order to generate static information about target application software 101, protection process 100 includes a step for performing metrics analysis of the source code 110. At least 28 different metrics are gathered for the source code. FIG. 3 illustrates one mbodiment for performing metrics analysis of the source code 110. First, a static analyzer 300 is used to statically analyze the source code. Those skilled in the art can appreciate that any known static analyzer 300 can be used to examine the text of the source code without executing the program. Metrics data are collected 304 and stored in a metrics database 306. Metrics data are also reported 308 in the form of a metrics report 310 that users can utilize to discern potential security issues with source code of target application software 101. In one embodiment, protection process 100 also generates a strategy vector 116 related to static metrics.

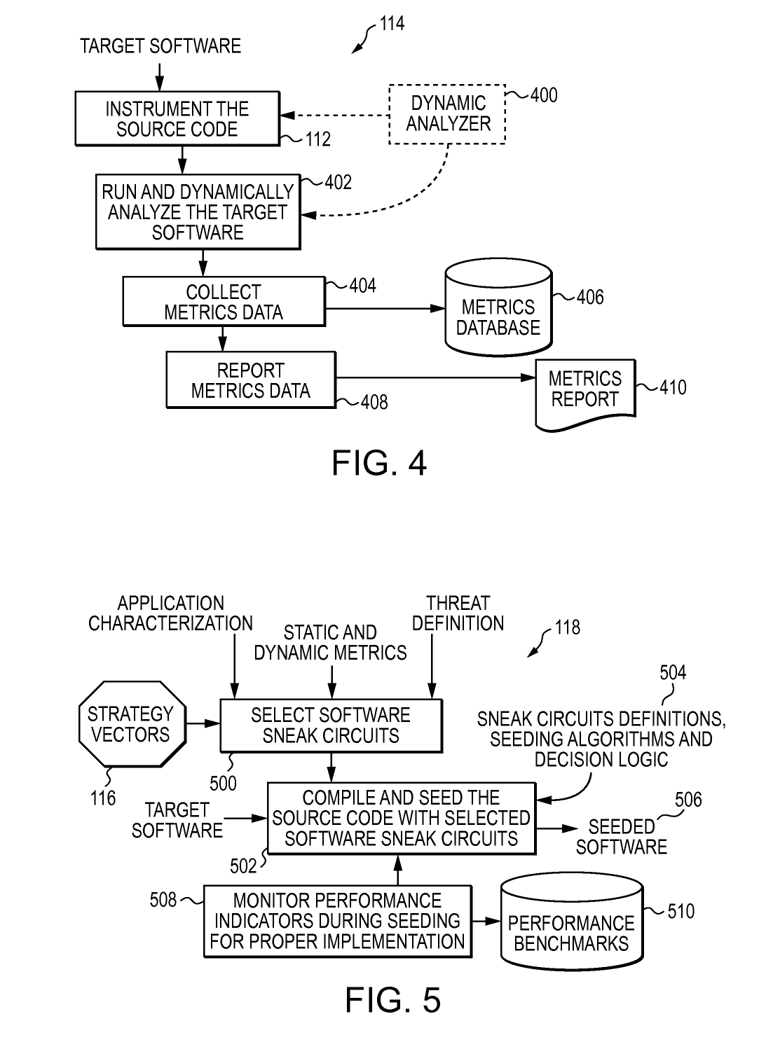

Protection process 100 includes a step for executing the source code of target application software 101, or instrument application software source code 112. Referring now to FIG. 4, once the source code has been executed, protection process 100 includes a dynamic analyzer 400 for performing dynamic metrics analysis of the instrumented code 114. At least 17 different metrics are gathered relating to the source code by running instrumented source code on a computer to provide dynamic or behavioral information about target application software 101. Those skilled in the art appreciate that dynamic analyzer 400 can be any known dynamic analysis tool that uses test data sets to execute application software in order to observe its behavior. Metrics data regarding the dynamic analysis is collected 404 and stored in a metrics database 406. Metrics data are also reported 408 in the form of a metrics report 410 that users can utilize to identify security issues with executed source code, including source code being executed and source code after it has been executed. In one embodiment, protection process 100 also generates a strategy vector 116 related to dynamic metrics.

Based on the results of analyzing and understanding the source code, target application software 101 is seeded with a variety of software sneak circuits using developed decision logic that balances protection indicators with computational performance indicators measured in terms of central processing unit (CPU) performance, memory utilization and cache hits 118. The term “sneak circuit” as used herein means an unexpected path or logic flow that, under certain circumstances, can produce an undesired effect. Software sneak circuits protect the target application software 101 statically by obfuscating the application software source code or computer hardware. Obfuscation is aimed at making those who are trying to reverse engineer or tamper with executables that are distributed as deliverable versions of source code believe that they have been successful in their exploit, when they have not.

The software sneak circuits include, but are not limited to, sneak data, sneak logic, sneak paths, sneak timing, sneak indication, sneak labels and sneak signatures. The term “sneak data” as used herein means ambiguous or false data used to make it more difficult for exploiters to understand the text and operation of the source code. The term “sneak logic” as used herein means unexpected or ambiguous logic used to confuse exploiters. The term “sneak paths” as used herein means unexpected paths along which logic flows in an unintended manner. The term “sneak timing” as used herein means events occurring in an unexpected or conflicting sequence. The term “sneak indications” as used herein means ambiguous or false displays of system operating conditions that may cause the system or an operator to take an undesired action. The term “sneak labels” as used herein means incorrect or imprecise labeling of system functions. The term “sneak signatures” as used herein means false information used to confuse tools exploiters use. Those skilled in the art can appreciate that software sneak circuits can be written in and/or discernable by any code in order to be compatible with target application software 101.

FIG. 5 shows one embodiment of a method for seeding target application software 101 with software sneak circuits 118. Software sneak circuits are embedded in the source code in a performance-sensitive and scalable manner to protect target application software 101 against reverse engineering and tampering 500 by making it hard for exploiters to understand the program logic, reconstruct the jump table and rebuild the symbol table. In addition, sneak circuits 118 make run-time behavior difficult to comprehend especially in weapons systems where the processing of the many tasks that run parallel must be synchronized and interruptions must be processed in real-time. In one embodiment, strategy vectors 116, collected benchmark data 108, performing static metrics analysis 110 and dynamic metrics analysis 112 can be used to select software sneak circuits 500. The source code of target application software 101 is then compiled and seeded with the selected sneak circuits 502. Sneak circuits definitions, seeding algorithms and decision logic 504 can be incorporated to compile and seed the source code. In one embodiment, sneak circuits 118 are easily removed from the source code for maintenance purposes using an encrypted key that is provided to authorized personnel during the boot sequence of target application software 101.

Information gathered while monitoring seeding performance indicators for proper implementation 508 can also be used when compiling and seeding the source code. After the source code has been compiled and seeded with sneak circuits, it is considered seeded software 506. Seeding performance benchmarks 510 can also be generated while monitoring performance indicators during seeding for proper implementation 508. Those skilled in the art can appreciate that seeding performance benchmarks 510 can be used as inputs for other aspects of protection process 100, for manual analysis by users, or a combination thereof.

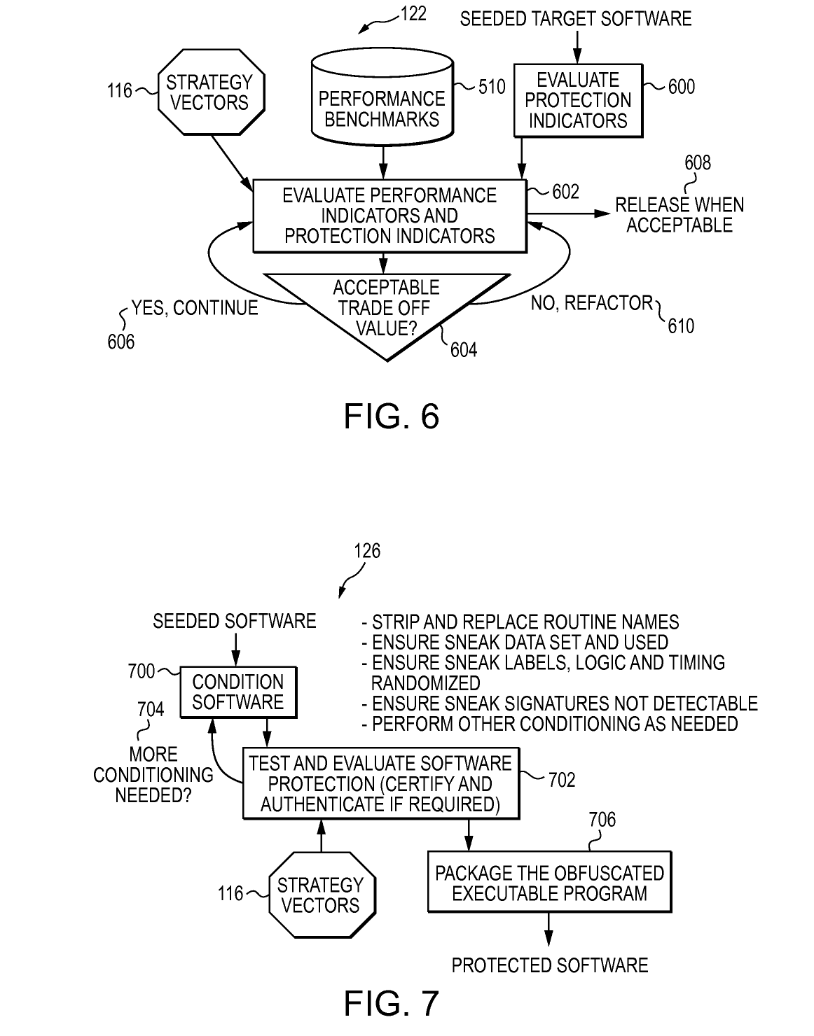

After the source code of target application software 101 is seeded, it is tested to determine whether the protection indicators and performance indicators were satisfactory. The test is conducted by running the protected target application software 101 in test mode on a target computer 120 and assessing performance indicators versus protection indicators for the source code as it is being run 122. FIG. 6 illustrates one embodiment for analyzing performance indicators and protection indicators 122. Seeded software is analyzed to evaluate protection indicators 600. Considering strategy vectors 116 and performance benchmarks 510, an evaluation is conducted to analyze performance indicators versus protection indicators 602. Those skilled in the art can appreciate that various factors can impact performance indicators in a positive manner while potentially decreasing security, or having a negative impact on protection indicators, and vice versa. For example, certain types of protection can increase run times for executables. Accordingly, in this embodiment, protection process 100 includes step 602 for analyzing performance indicators versus protection indicators to determine whether a predetermined tradeoff value 604 has been achieved. If an acceptable tradeoff value has not been achieved, seeding is modified and the re-seeded software is re-tested 610 (also 124 on FIG. 1). If an acceptable tradeoff value has been achieved 606, protection procedure 100 commences by releasing the seeded software 608.

In one embodiment, before release, the protected application software 136 is conditioned for release 126. Conditioning involves performing obfuscation and/or additional procedures aimed at making it difficult for those reverse engineering the source code to figure out the true logic and behavioral characteristics. FIG. 7 illustrates one method for conditioning the protected software 136 for release 126. The seeded application software is conditioned 700 by stripping and replacing routine names with pseudonyms; ensuring sneak data is set and used; ensuring sneak labels, logic and timing are randomized; ensuring sneak signatures are up-to-date and not detectable; and performing other conditioning as needed. The protected application software 136 is then tested and evaluated based 702 on strategy vectors 116. If more conditioning is needed, the protected application software 136 is returned for more conditioning 700. When an acceptable level of conditioning is achieved, the protected application software 136 is released to the field 608 for distribution.

After conditioning is complete, protection process 100 includes a step for inserting active protection 128. Specialized hidden code is added to the protected application software 136 as executables to actively respond to reverse engineering and tampering exploits. Such code recognizes signatures of attack and takes pre-programmed action like enabling an alert, taking evasive actions and routing the attacker to a honeypot to collect forensics data. The term “honeypot” as used herein means computer logic that is set up to trap crackers when they try to penetrate computer systems without authorization. Honeypots are used to collect forensics information during an exploit. The forensics information is often used as evidence to prosecute intruders. Inserting active protection 128 improvements further protects protected application software 136 from new threats that occur over time.

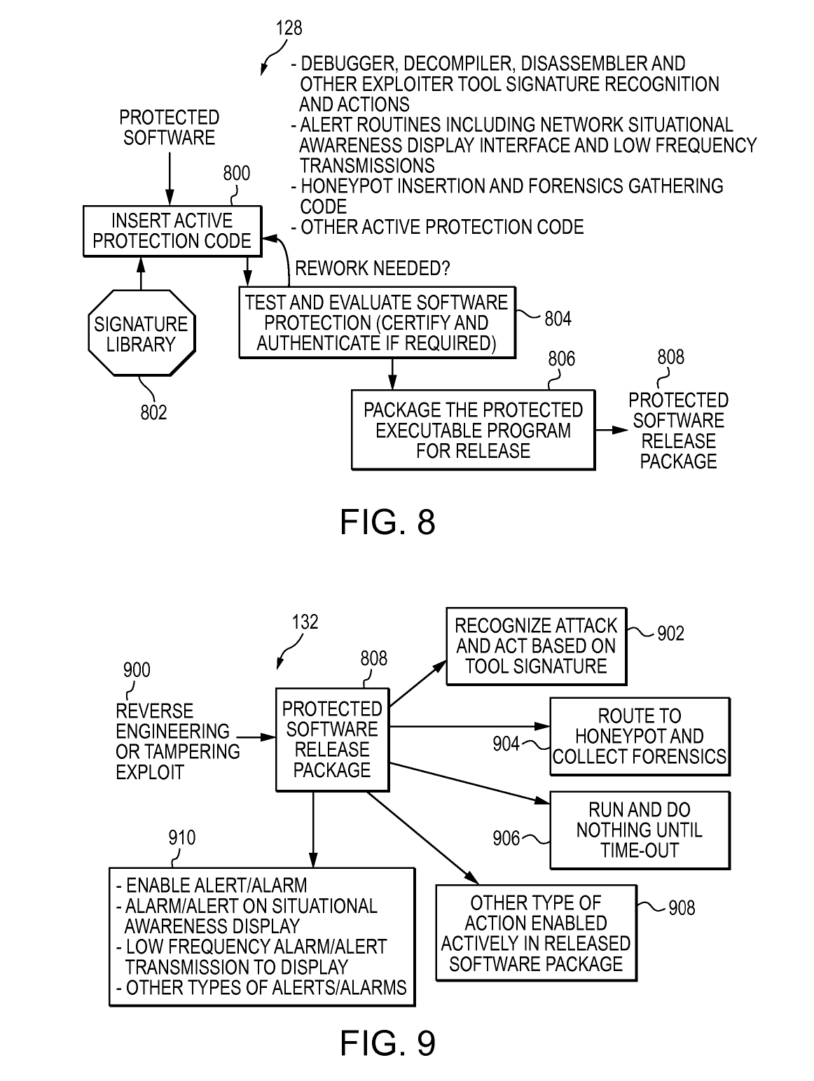

FIG. 8 illustrates one embodiment for a procedure that inserts active protection code 128. Active protection code can include debuggers, decompilers, disassemblers and low frequency transmissions to set alarms and/or send alerts. Active protection code can also include network situational awareness display interfaces and low frequency transmissions. Additionally, active protection code can include honeypot insertion and forensics data gathering code as well as any other known active protection code. Active protection code is embedded in the protected software 800. In one embodiment, the active protection code can access a signature library 802 for storing, comparing and verifying digital signatures. The application software is tested and evaluated 804 to ensure that protection indicators are acceptable. In one embodiment, a digital certificate or authentication can be provided. After the active protection code has been inserted, the protected executable program is packaged for release 804 creating a protected software release package 808.

After the protected application software 136 is released 132, protection process 100 captures forensic data 134 and new signatures 142 of attack Forensics data is captured based on tool signatures. Those skilled in the art will appreciate that tool signatures are unique arrangements of information that can be used to uniquely identify tools that intruders use to crack software. This information includes, but is not limited to, the address in computer memory where the tools and software are loaded and the sequences of operations that occur when the tools initiate processing. In one embodiment, as shown in FIG. 9, protection process 100 provides code that respond to reverse engineering attempts and tampering exploits in pre-programmed ways to confuse those trying to reverse engineer and tamper with application software 101, provide alerts and/or capture forensics data. Protected software release package 808 is subjected to attempts at unauthorized access, reverse engineering or tampering exploits 900 in a test environment. In one embodiment, the attempts at unauthorized access, reverse engineering or tampering attacks are recognized and subsequent actions are based on a tool signature 902. In an alternate embodiment, protected application software release package 808 is routed to a honeypot in order to collect forensics data after being subjected to attempts at unauthorized access, reverse engineering and tampering exploits 904. In another embodiment, protected application software release package 808 is run with no other actions being taken until a time-out is reached 906. In still another embodiment, other types of protective actions can be actively enabled 908 after protected application software release package 808 is subjected to attempts at unauthorized access, reverse engineering or tampering exploits 900. In yet another embodiment, an alert/alarm is enabled 910. Alert/alarms include an alert/alarm on a situational awareness display, a low frequency alert/alarm transmitted to a display, or other types of known alert/alarms.

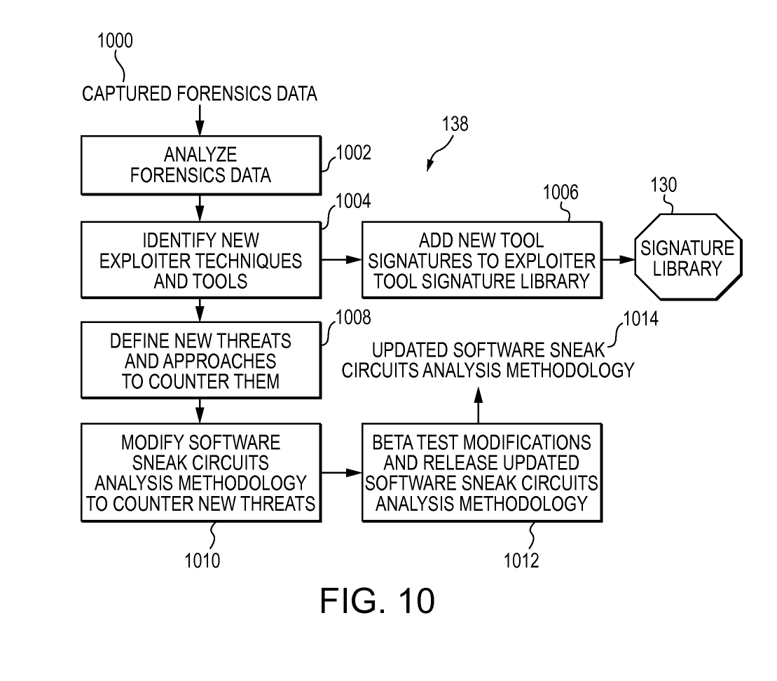

Protection process 100 is improved by using forensics data 138 to response to evolving threats resulting in an improved protection process methodology 140. FIG. 10 illustrates one embodiment for a procedure that uses forensics data to improve protection process 100. Forensics data is captured 1000 and analyzed 1002 when running the protected application software. New exploiter techniques and tools are identified 1004 based on analysis 1002 of the forensics data. When new exploiter tools and techniques are identified, new signatures 142 are added to exploiter tool signature library 1006 in signature library 130. These new exploiter techniques and tools, or new threats, are defined and approaches are developed for countering them 1008. Software sneak circuit analysis procedures (as illustrated by example in FIG. 5 above) are modified to counter the new threats 1010. The modified and released updated software sneak circuit analysis procedures are beta tested 1012 to create an updated software sneak circuit analysis methodology 1014.

While the foregoing embodiments were based on executable application software, in one embodiment, sneak circuit concepts can be used to protect computer hardware (components, assembles, devices, backplanes, etc.) against reverse engineering and tampering. Sneak circuits could be embedded in hardware using similar performance-sensitive, protect-in-depth strategies to provide cost-effective protection of the hardware from unauthorized access, reverse engineering and/or tampering.

While the invention has been described with reference to the specific embodiments thereof, those skilled in the art will be able to make various modifications to the described embodiments of the invention without departing from the true spirit and scope of the invention. The terms and descriptions used herein are set forth by way of illustration only and are not meant as limitations. Those skilled in the art will recognize that these and other variations are possible within the spirit and scope of the invention as defined in the following claims and their equivalents.

What is claimed is:

1. A method for protecting application software from reverse engineering or tampering, comprising:
seeding said application software with sneak circuits based on performance indicators;
running said application software in test mode after said seeding;
analyzing performance indicators and protection indicators of said application software while running said application software in said test mode;
modifying seeding if said performance indicators and said protection indicators reach a predetermined tradeoff value; and
inserting active protection code in said application software.

2. The method of claim 1 further comprising establishing strategy vectors derived from static metrics analysis of said application software and dynamic metrics analysis of said application software before said seeding.

3. The method of claim 1 further comprising conditioning for obfuscating source code of said application software before said inserting active protection code.

4. The method of claim 1 further comprising:
releasing a protected version of said application software for execution in normal mode after said inserting active protection code; and
collecting forensics data collected while executing said protected version.

5. The method of claim 2 wherein said strategy vectors are a function of application software size.

6. The method of claim 2 wherein said strategy vectors are a function of an application domain for said application software.

7. The method of claim 2 wherein said strategy vectors are a function of an application software threat.

8. The method of claim 2 wherein said strategy vectors are a function of benchmark performance data related to said application software.

9. The method of claim 2 further comprising using a static analyzer to statically analyze source code of said application software, collecting static metrics data and reporting said static metrics data in a metrics report.

10. The method of claim 2 further comprising using a dynamic analyzer to dynamically analyze said application software, collecting dynamic metrics data, storing said dynamic metrics data in a dynamic metrics database, and reporting said dynamic metrics data in a metrics report.

11. The method of claim 1 further comprising storing seeding performance benchmarks after analyzing performance indicators and protection indicators.

12. The method of claim 1 wherein said sneak circuits are selected from the group consisting essentially of sneak data, sneak logic, sneak paths, sneak timing, sneak indication, sneak labels and sneak signatures.

13. The method of claim 1 wherein said active protection code is selected from the group consisting essentially of debuggers, decompilers, disassemblers, exploiter tool signature recognition, alert routines, situational awareness display interfaces, low frequency transmissions, and honeypot insertion used to provide gathering of forensics code based on tool signatures.

14. The method of claim 4 wherein said collecting forensics data further comprises analyzing said forensics data; identifying new exploiter techniques and tools; defining new threats and approaches for countering said new threats; modifying said sneak circuits to counter said new threats; testing modified software application; and releasing said modified software application.

15. A computer program stored on a computer readable medium for programming a computer to protect application software from reverse engineering or tampering, the computer program comprising:
a computer code segment for seeding said application software with sneak circuits based on performance indicators;
a computer code segment for running said application software in test mode after said seeding, the running for analyzing said performance indicators and protection indicators of said application software;
a computer code segment for modifying seeding if said performance indicators and said protection indicators reach a predetermined tradeoff value; and
a computer code segment for inserting active protection code in said application software.

16. The program of claim 15 further comprising a computer code segment for establishing strategy vectors derived from static metrics analysis of said application software and dynamic metrics analysis of said application software for providing assistance in developing performance indicators.

17. The program of claim 15 further comprising a computer code segment for conditioning for obfuscating source code of said application software after running said application software in said test mode.

18. The program of claim 15 further comprising:
a computer code segment for releasing a protected version of said application software for execution in normal mode after said modifying; and
a computer code segment for collecting forensics data collected while executing said protected version.

19. The program of claim 16 wherein said strategy vectors are a function of application software size.

20. The program of claim 16 wherein said strategy vectors are a function of an application domain for said application software.

21. The program of claim 16 wherein said strategy vectors are a function of an application software threat.

22. The program of claim 16 wherein said strategy vectors are a function of benchmark performance data related to said application software.

23. The program of claim 16 further comprising using a static analyzer to statically analyze source code of said application software, collecting static metrics data and reporting said static metrics data in a metrics report.

24. The program of claim 16 further comprising using a dynamic analyzer to dynamically analyze said application software, collecting dynamic metrics data, storing said dynamic metrics data in a dynamic metrics database, and reporting said dynamic metrics data in a metrics report.

25. The program of claim 15 further comprising a computer code segment for storing seeding performance benchmarks after analyzing performance indicators and protection indicators.

26. The program of claim 15 wherein said sneak circuits are selected from the group consisting essentially of sneak data, sneak logic, sneak paths, sneak timing, sneak indication, sneak labels and sneak signatures.

27. The program of claim 15 wherein said active protection code is selected from the group consisting essentially of debuggers, decompilers, disassemblers, exploiter tool signature recognition, alert routines, situational awareness display interfaces, low frequency transmissions, and honeypot insertion used to provide gathering of forensics code based on tool signatures.

28. The program of claim 18 wherein the computer code segment for collecting said forensics data further comprises identifying new exploiter techniques and tools; defining new threats and approaches for countering said new threats; modifying said sneak circuits to counter said new threats; testing modified software application; and releasing said modified software application.

29. A system for protecting application software from reverse engineering or tampering, comprising:
a seeding module for augmenting said application software with sneak circuits based on performance indicators;
a running module for analyzing said performance indicators and protection indicators of said application software in test mode after said seeding;
a modifying module for updating seeding if said performance indicators and said protection indicators reach a predetermined tradeoff value; and
a protecting module for inserting active protection code in said application software.

30. The system of claim 29 further comprising an establishing module for deriving strategy vectors from static metrics analysis of said application software and dynamic metrics analysis of said application software for providing assistance in developing performance indicators.

31. The system of claim 29 further comprising a conditioning module for obfuscating source code of said application software.

32. The system of claim 29 further comprising:
a releasing module for executing a protected version of said application software in normal mode after inserting said active protection code; and
a collecting module for gathering and storing forensics data collected while executing said protected version.

33. The system of claim 30 wherein said strategy vectors are a function of application software size.

34. The system of claim 30 wherein said strategy vectors are a function of an application domain for said application software.

35. The system of claim 30 wherein said strategy vectors are a function of an application software threat.

36. The system of claim 30 wherein said strategy vectors are a function of benchmark performance data related to said application software.

37. The system of claim 30 further comprising a static analyzing module for statically analyzing source code of said application software, collecting static metrics data and reporting said static metrics data in a metrics report.

38. The system of claim 30 further comprising a dynamic analyzing module for to dynamically analyzing said application software, collecting dynamic metrics data, storing said dynamic metrics data in a dynamic metrics database, and reporting said dynamic metrics data in a metrics report.

39. The system of claim 29 further comprising a storing module for saving seeding performance benchmarks after analyzing performance indicators and protection indicators.

40. The system of claim 29 wherein said sneak circuits are selected from the group consisting essentially of sneak data, sneak logic, sneak paths, sneak timing, sneak indication, sneak labels and sneak signatures.

41. The system of claim 29 wherein said active protection code is selected from the group consisting essentially of debuggers, decompilers, disassemblers, exploiter tool signature recognition, alert routines, situational awareness display interfaces, low frequency transmissions, and honeypot insertion to provide gathering of forensics code based on tool signatures.

42. The system of claim 32 wherein said collecting module further comprises evaluating said forensics data; identifying new exploiter techniques and tools; defining new threats and approaches for countering said new threats; modifying said sneak circuits to counter said new threats; testing modified software application; and releasing said modified software application.

43. A system for protecting application software from reverse engineering or tampering, comprising:
means for seeding said application software with sneak circuits based on performance indicators;
means for analyzing performance indicators and protection indicators of said application software in test mode after said seeding;
means for modifying seeding if said performance indicators and said protection indicators reach a predetermined tradeoff value; and
means for inserting active protection code in said application software.

44. The system of claim 43 further comprising means for establishing strategy vectors from static metrics analysis of said application software and dynamic metrics analysis of said application software for providing assistance with developing performance indicators.

45. The system of claim 43 further comprising means for conditioning said application software to obfuscate source code of said application software.

46. The system of claim 43 further comprising:
means for executing a protected version of said application software in normal mode after inserting said active protection code; and
means for collecting forensics data while executing said protected version.

47. The system of claim 44 wherein said strategy vectors are a function of application software size.

48. The system of claim 44 wherein said strategy vectors are a function of an application domain for said application software.

49. The system of claim 44 wherein said strategy vectors are a function of an application software threat.

50. The system of claim 44 wherein said strategy vectors are a function of benchmark performance data related to said application software.

51. The system of claim 44 further comprising a static analyzing means for statically analyzing source code of said application software, collecting static metrics data and reporting said static metrics data in a metrics report.

52. The system of claim 44 further comprising a dynamic analyzing means for to dynamically analyzing said application software, collecting dynamic metrics data, storing said dynamic metrics data in a dynamic metrics database, and reporting said dynamic metrics data in a metrics report.

53. The system of claim 43 further comprising a storing means for saving seeding performance benchmarks after analyzing performance indicators and protection indicators.

54. The system of claim 43 wherein said sneak circuits are selected from the group consisting essentially of sneak data, sneak logic, sneak paths, sneak timing, sneak indication, sneak labels and sneak signatures.

55. The system of claim 43 wherein said active protection code is selected from the group consisting essentially of debuggers, decompilers, disassemblers, exploiter tool signature recognition, alert routines, situational awareness display interfaces, low frequency transmissions, and honeypot insertion used to provide gathering of forensics code based on tool signatures.

56. The system of claim 46 wherein said means for collecting forensics data further comprises evaluating said forensics data; identifying new exploiter techniques and tools; defining new threats and approaches for countering said new threats; modifying said sneak circuits to counter said new threats; testing modified software application; and releasing said modified software application.
